(19) United States
(12) Patent Application Publication
(10) Pub. No.: US 2024/0359366 A1
(43) Pub. Date: Oct. 31, 2024

(54) METHOD FOR SHREDDING AND RECYCLING USED BIG-BAGS AND FACILITY FOR IMPLEMENTING THE METHOD

(71) Applicants: ALL SUN, Bezu-Saint-Eloi (FR); TECHNI-TERRE, Etrepagny (FR)

(72) Inventors: Luc Letierce, Eragny sur Epte (FR); Rémi Durand, Etrepagny (FR); Jean-Pierre Tournerie, Fleury la Forêt (FR); Laurent Girodet, St Martin aux Arbres (FR)

(73) Assignees: ALL SUN, Bezu-Saint-Eloi (FR); TECHNI-TERRE, Etrepagny (FR)

(21) Appl. No.: 18/291,824

(22) PCT Filed: Jul. 22, 2022
(86) PCT No.: PCT/EP2022/070667

§ 371 Date: Jan. 24, 2024

(30) Foreign Application Priority Data
Aug. 3, 2021 (EP) 21189417.5

(51) Int. Cl. B29B 17/02; B03B 9/06; B09B 3/32; B09B 3/35; B09B 101/75; B29B 17/00; B29B 17/04; B29K 23/00; B29K 105/26

(52) U.S. Cl. CPC B29B 17/02; B03B 9/06; B09B 3/32; B09B 3/35; B29B 17/0412; B09B 2101/75; B29B 2017/0015; B29B 2017/0021; B29B 2017/0203; B29B 2017/0227; B29B 2017/0241; B29B 2017/0476; B29K 2023/06; B29K 2023/12; B29K 2105/26

(57) ABSTRACT

The method for shredding and recycling used big-bags, having a continuous internal bag of polyethylene and an external outer of polypropylene, includes: compacting at least one big-bag to a thickness of less than 20 cm; conveying the compacted big-bag(s) to a shredding unit; shredding at least one compacted big-bag at the shredding unit, between 100 and 1000 cuts/m being performed on the compacted big-bag(s) to obtain strips of the PE outer and fragments of the PP outer; separating the PE strips from the PP fragments to obtain a first fraction of PP fragments and a second fraction of PE strips: applying a second shredding of the polyethylene strips; cleaning the two fractions; feeding first and second extruders respectively with the cleaned first fraction to obtain PP granules and with the cleaned second fraction to obtain PE granules.

The present invention relates to the field of recycling, and more particularly to the recycling of plastic materials.

The present invention more specifically relates to a method for recycling plastic products manufactured from two main plastic components, ensuring optimal separation of these two components, as well as a facility enabling the implementation of the method of the invention.

The method of the present invention is most particularly indicated for recycling large flexible bags of the “big-bag” type, which are in particular used in the agricultural environment for storing and/or transporting seeds or granules.

Big-bags, also known as Large Flexible Bulk Containers, are containers in the form of bags consisting of two elements:
an internal bag consisting of a continuous film manufactured from polyethylene material (abbreviated as PE in the remainder of the description), and generally having a grammage of between 50 and 100 g/m²;
a strong polypropylene (abbreviated as PP in the remainder of the description) external outer, generally having a grammage of between 100 and 200 g/m².

The weight of an empty big-bag is about 1.3 kg, and its volume is generally 1 m³, with a PP-PE mass proportion of the order of ⅔ of PP for ⅓ of PE.

These two elements, internal bag and external outer, are secured by stitching and/or by bonding. The stitching yarns are also made of a plastic, polypropylene, polyamide or even polyester type material.

A big-bag is provided with straps to enable its handling, for example by means of a forklift.

When this big-bag is used, for example for packing moisture sensitive materials such as granules, the bag is held at height above a container and the bottom is then slit to extract the contents, which pour out.

Once the big-bags are thus slit and emptied, or when the latter are used, they are stored flat, in bundles, and pressed, thus becoming waste that should be processed, and insofar as possible, recycled for obvious environmental reasons.

In this respect, it is essential to effectively separate the two plastic materials, PP and PE, respectively constituting the external outer and the internal bag of the big-bag.

Such a separation of the two elements, internal bag and external outer, constituting a big-bag, can be carried out manually by an operator.

However, such an operation inevitably requires a great deal of time.

Big-bags can also be completely shredded by machines, so that the two constituent plastic materials of the bags, polyethylene and polypropylene, are mixed together in shredded material.

The recycling of big-bags is therefore problematic because it is difficult to effectively separate the polypropylene of the external outer of the polyethylene which composes the internal bag, once these elements are shredded and mixed. Indeed, current shredding technologies do not make it possible to produce different morphologies of the components that are shredded, so that subsequent attempts to separate the basic materials, PP and PE, are not effective.

Known from the prior art is Polish patent PL 428008 which proposes a method for recycling bags of the used big-bags type manufactured based on polypropylene (PP) or a polypropylene/polyethylene (PP/PE) mixture.

In this recycling method, the following steps are carried out sequentially:
dry pre-shredding of the bags in order to obtain shreds of a size less than or equal to 80 mm;
two washings of these shreds, then centrifuging and/or pressing to remove excess water therefrom;
second shredding in order to obtain flakes of a size less than or equal to 60 mm;
compacting and then melting, mixing and single-screw extrusion between 240° and 260° C., filtering the molten mass through a 0.6 mm mesh screen;
finally degassing, re-extrusion, again by filtering through a screen, then granulation.

Thus, a recycling solution is proposed based here on a sequence of shreddings-washings-melting and finally filtering, wherein it is sought to obtain a shredded material that is both homogeneous and free of impurities.

The implementation of this method on a bag manufactured from a PP/PE mixture, wherein it is sought to obtain a shredding of plastic materials having a relatively homogeneous particle size, does not allow separation of said two plastic materials.

European patent document EP 2 371 508 describes a method for recycling packaging of dairy products, composed of a polymer sheet and a sealing film.

In this method, the waste is shredded before it is mechanically separated by cyclonic precipitation, aimed at separating the heavy particles, comprising predominantly the polymer sheet, from the light particles.

The light particles are then passed through the screen to separate the particles of very small dimensions from the sealing film.

The heavy polymer particles are then gathered together with the particles resulting from the separation by screening and are merged before filtration of the molten polymer.

Also known, from patent document CN 111546536, is a method for recovering woven plastic bags, intended to contain fertilizers or chemical products, wherein the bags are flattened and then pressed, seeking to avoid the formation of folds that could jam the machines. Both sides of the bags are then brushed and washed.

Proposed in documents CN 210 233 640 and CN 210 211 005 are methods of shredding woven plastic bags composed of a PP outer, and an internal PE bag; these bags are used to pack fertilizer or chemical products. In these methods, the bags are shredded by means of a knife mill.

In document CN 209 365 131, the cutting-shredding of the bags is carried out by a helical blade and air extractor, to avoid manual pre-cutting of the bags and to generate less dust.

The document CN 209 036 777 relates to the recycling and cleaning of woven PP bags for use in industry or agriculture.

The method described is sequential:
first shredding of the bags,
cleaning with water in two tanks,
second shredding,
re-washing
separation of the materials by sedimentation, and
dehydration

Also known from Japanese patent application JP 2017 014316, is a recycled composite resin used for an extrusion drawing product, such as a drawing band for packaging or similar, by reusing a flexible container.

The recycled composite resin is obtained by mixing a polypropylene homopolymer resin with a recycled raw material manufactured by shredding and melting a flexible container containing a mixture of PP and PET (removed by filtration through a mesh unit or fused with PP), and where at least 80% by weight of a thermoplastic resin component contained in the recycled composite resin is polypropylene.

However, and as already indicated above, the methods proposed in the prior art are sometimes complex and expensive to implement, and/or do not allow optimal separation for recycling of the various components of the bags manufactured from different polymers.

Therefore, it is common that, after shredding, the basic plastic materials of the big-bags, PP and PE, are not properly separated and are melted together to be transformed into reusable granules.

This results in a final material which, although recycled, has mediocre physical performance due to the chemical incompatibility between the PP and the PE.

Thus, certain recycled products currently available on the market, and manufactured from granules, whose composition inevitably comprises a mixture of these two plastic materials, have mechanical characteristics that are lower than those of a product, in this case a big-bag, the components of which, internal bag and external outer, are manufactured respectively from pure or virtually pure PE and PP.

The present invention seeks to remedy, at least in part, the disadvantages of the methods known in the prior art for shredding and separating plastic materials that make up the two elements of a big-bag.

The solution devised by the inventors consists in combining a specific technology for shredding big-bag type bags with a separation of the two plastic materials which compose them, based on a difference in morphology of these materials obtained following the specific shredding.

Thus, the subject matter of the present invention is firstly a method for shredding and recycling used big-bags consisting of a continuous internal bag made of polyethylene and an external woven outer made of polypropylene.

The method of the invention is particular in that it comprises at least the following steps, taken in order:
At least one big-bag is compacted to a thickness of less than 20 cm;
Said at least one compacted big-bag is conveyed to a shredding unit;
Said at least one compacted big-bag is shredded at a shredding unit, the feed rate at which said compacted big-bag is conveyed to the shredding unit and the cutting frequency of the latter being such that between 100 and 1000 cuts/m are performed on said compacted big-bag(s) so as to obtain, on the one hand, strips of polyethylene from the internal bag, the strips having a width of between 1 and 10 mm and a length of up to 1000 mm, and, on the other hand, fragments of the external polypropylene outer in the form of partially unwoven pieces and filaments having a width of 1 to 2 mm and a length of up to 500 mm;
Said polyethylene strips are separated from the polypropylene fragments and a first fraction of polypropylene fragments and a second fraction of polyethylene strips are obtained, the latter being processed by performing a second shredding of the polyethylene strips;
Said two fractions are cleaned by performing, on each of the fractions, at least:
air separation;
dust removal;
washing with water;
A first extruder is fed with said first cleaned fraction of polypropylene fragments in order to obtain polypropylene granules and a second extruder is fed with said second cleaned fraction of shredded polyethylene strips in order to obtain polyethylene granules.

Preferentially, the step of separation between said strips of polyethylene and the polypropylene fragments is carried out by shaking, in particular by means of a separation unit comprising at least one shaker able to separate a first fraction of polypropylene fragments from a second fraction of polyethylene strips.

According to particular embodiments of the method of the invention:
between 200 and 500 cuts/m of compacted big-bag are applied;
in a first alternative embodiment of the method, at least one compacted big-bag is conveyed to the shredding unit by means of a conveyor belt at a feed rate of between 14.4 m/min and 144 m/min, and said shredding unit at which the shredding is performed consists of a multi-blade rotor, the cutting frequency of which is equal to 240 cuts per second;
preferentially, in this first variant, said at least one compacted big-bag is conveyed to the shredding unit at a feed rate of between 28.8 and 72 m/min;
in a second alternative embodiment of the method, said at least one compacted big-bag is conveyed to the shredding unit by means of a conveyor belt, at a feed rate of between 0.25 m/min and 2.5 m/min, and said shredding unit at which the shredding is performed consists of a guillotine cutter, the cutting frequency of which is equal to 250 cuts per minute;
the at least one compacted big-bag is conveyed to the shredding unit at a feed rate of between 0.5 and 1.25 m/min;
the said at least one big-bag is compacted to a thickness of between 3 and 5 cm;
during the step of cleaning said two fractions, the following are performed:
on each of said two fractions, a first air separation capable of enabling the extraction of the heaviest contaminants, in particular metal, wood, paper, mineral particles;
on the second fraction containing the strips of PE, a second air separation capable of enabling the elimination of the PP and lowering the proportion of said PP within said second fraction to a content of less than 1%.

The present invention also relates to a facility for shredding and recycling used big-bags, consisting of a continuous internal polyethylene bag and an external woven polypropylene outer, for the implementation of the method of the invention.

It comprises a unit for compacting at least one big-bag, downstream from which a feed conveyor is arranged, feeding compacted big-bag(s) to a shredding unit comprising means for cutting said at least one big-bag into raw shredded material composed of polyethylene strips on the one hand, and fragmented polypropylene particles on the other hand.

Said facility further comprises means for feeding a loader with raw shredded material, comprising means for calibrating and managing the feed stream of said shredded material into a separation unit comprising at least one shaker able to separate a first fraction of polypropylene fragments from a second fraction of polyethylene strips.

The facility is also provided with first means for conveying said second fraction from the shaker to a second shredding unit, second means for conveying said second shredded fraction from said second shredding unit to a separation and cleaning unit and fourth means of conveying said first fraction of fragments directly from said shaker to said separation and cleaning unit. Downstream of this unit first extrusion means are located, which are supplied with said first cleaned fraction of polypropylene fragments and second extrusion means supplied with said second cleaned fraction of shredded polyethylene strips.

In exemplary embodiments of the facility:
said shaker comprises, in its lower part, an apron composed of a plurality of fixed grids or parallel bars, two grids or two adjacent bars being separated by a distance of between 1 and 3 cm, said shaker further comprising, in its upper part, a succession of a plurality of articulated rods containing tips, which rods are driven by an alternating and irregular rotational movement from 20 to 90°;
the cutting means of the shredding unit consists of a multi-blade rotor;
the cutting means of the shredding unit consists of a guillotine cutter.

Further objects and advantages of the present invention will become apparent throughout the following description relating to embodiments which are provided only as indicative and non-limiting examples.

The present invention relates more particularly, firstly, to a method for shredding and recycling used big-bags.

The invention described herein also relates to a facility for implementing the method of the invention. This will be described later in the description.

Big-bags that are intended to be processed by means of the method of the invention consist of containers in the form of large bags, which consist of two elements obtained from two distinct plastic materials. Thus, a big-bag conventionally comprises, on the one hand, a continuous internal bag made of polyethylene (PE) and, on the other hand, an external woven outer made of polypropylene (PP).

The method of the present invention, when it is implemented on used big-bags traditionally used in the agricultural field, makes it possible, particularly advantageously, to produce differentiated fragments of each of the plastic materials, PE and PP, which constitute the base product.

Thus, each of the two plastic materials PE and PP can easily be recycled separately from one another, and without one being contaminated with the other.

The invention relates more specifically to a method for shredding and recycling used big-bags, the composition of which has been described above.

In a first step of the method, the big-bag(s) to be processed are compacted so as to form a bed with a thickness of less than 20 cm comprising the material to be processed, and more preferentially a thickness of between 3 and 5 cm.

In a second step, the big-bag(s) thus compacted feed(s) a shredding unit, through suitable means of conveyance, in particular a conveyor belt.

In a subsequent step of the method that is the subject of the invention, the compacted big-bag(s) is (are) shredded.

According to one particular feature of the method of the invention for shredding and recycling big-bags, the means for conveying the compacted big-bag(s) from the compacting unit to the shredding unit, as well as the cutting frequency of the latter, are adjusted in such a way that, at the time of shredding, a number of cuts are applied of between 100 and 1000, preferably between 200 and 500 cuts per meter of compacted big-bag(s), which arrive at the shredding unit by the conveyor belt.

In other words, the cutting frequency of the cutting means of the shredding unit on the one hand, and the feed rate of the compacted big-bags on the other hand are parameterized and correlated so as to arrive at such a number of cuts (between 100 and 1000 and preferably between 200 and 500) per unit of length (1 m) of compacted big-bags arriving at the shredding unit by means of the conveyor belt.

It has been demonstrated by the inventors that such values of number of cuts applied to a unit of length of compacted big-bags makes it possible, particularly advantageously, to obtain two mixed shreds: on the one hand, strips or long ribbons made of PE, with a width comprised between 1 and 10 mm, preferably from 2 to 5 mm, and a length ranging up to 1000 mm, coming from the continuous film of fibers constituting the internal bag of the big-bag, and, on the other hand, fragments of PP coming from the external outer of said big-bag, of very much smaller size than those of the PE strips. Indeed, as regards these PP fragments, they are in the form of partially unwoven pieces of a few square centimeters, and of single filaments with a width of 1 to 2 mm and of length up to 500 mm.

Thus, the implementation of the above-mentioned parameter in the method of the invention for shredding and recycling big-bags, namely a particularly high number of cuts per unit of length of product to be shredded, obtained by concomitantly adjusting the feed rate of the compacted big-bags and the cutting frequency of the cutting means comprised in the shredding unit, results in two differentiated morphologies of fragments of PP and PE being obtained.

These fragments, of differentiated morphologies, can be more readily separated in subsequent steps that will be detailed in the remainder of the present description, compared to PP and PE fragments having substantially homogeneous sizes and/or shapes which are obtained by implementing conventional shredding processes known from the prior art.

In a first embodiment of the method of the invention, which is particularly preferred, to achieve the number of cuts mentioned above and thus obtain differentiated fragments of PP/PE, at least one compacted big-bag, preferably several compacted big-bags, is conveyed in a regular manner to the shredding unit by means of a conveyor belt, the latter operating at a feed rate of between 14.4 m/min and 144 m/min.

In parallel to the regular speed of advance of the belt, said unit at which the shredding is carried out consists of a multi-blade rotor whose cutting frequency is particularly high and equal to 240 cuts per second.

In this first embodiment, again with a multi-cutter shredder operating at a frequency of 240 cuts/second, and in a particularly advantageous manner, the compacted big-bag(s) is (are) conveyed to the shredding unit at a feed rate of between 28.8 and 72 m/min.

Preferentially, in order to be cut at the shredding unit, the big-bags are compacted with a compacting thickness of less than 20 cm, preferentially between 3 and 5 cm.

In general, the width of entry into the multi-blade rotor of the shredding unit is of the order of 800 mm, and the working width is of the order of 600 mm.

The compacted density of the big-bags is estimated at a value of the order of 0.3.

The implementation of the method of the invention with such parameters of feed rate and cutting frequency results in a processing flow rate of the big-bags estimated at about 38.9 tons/hour.

In a second exemplary embodiment of the method of the invention, also making it possible to produce fragments of PP and PE having distinct morphologies that are easily dissociable from one another, said at least one compacted big-bag is conveyed in a regular manner to the shredding unit by means of a conveyor belt, at a feed rate that this time is between 0.25 m/min and 2.5 m/min.

In this second example, the cutting means comprised in said shredding unit at which the shredding of the big-bags is carried out consist of a guillotine cutter whose cutting frequency is equal to 250 cuts per minute, in order to achieve a number of cuts between 100 and 1000 per meter of compacted big-bags arriving at the shredding unit.

Advantageously, said at least one compacted big-bag is conveyed to the shredding unit at a feed rate of between 0.5 and 1.25 m/min to obtain a number of cuts of between 200 and 500 per meter of compacted big-bags arriving at the shredding unit.

Upon completion of the shredding step specific to the method of the invention, and regardless of the embodiment selected from those mentioned above in a non-limiting manner, a shredded material is obtained composed of a mass of two radically different morphologies: on the one hand, PE strips coming from the internal bag of the big-bags and, on the other hand, fragments of PP coming from the external outer.

From this shredded material, in a subsequent step of the method of the invention, said PE strips are separated from the PP fragments.

The separation of these two types of elements of different morphologies can be carried out by any means suitable for this purpose.

Most preferentially, a method of separation by shaking will be applied by means of a unit called “shaker” which will be described in more detail below in relation to the facility allowing the shredding and the recycling of used big-bags according to the invention.

Upon completion of this separation step, on one side a first fraction of polypropylene fragments is obtained, and on the other side a second fraction of polyethylene strips is obtained.

Most particularly, it was possible to demonstrate by the inventors that the degree of contamination by PE in the first fraction is less than 10%, whereas, in the second fraction of PE strips, the degree of contamination by PP fragments is less than 2%.

In a subsequent step of the method, which relates only to said second fraction, the strips of PE are shredded preferentially by means of a knife mill, in order to reduce their size.

Then, the two fractions undergo similar cleaning processing, each independently of one another.

More particularly, each of said two fractions is cleaned by performing at least the following sub-steps:
a first air separation; such a sub-step in the cleaning process initially makes it possible to extract the heaviest contaminants that could be in each of the two fractions, in particular metal, wood, paper, mineral particles and dirt, etc.;
optionally, a second air separation can be carried out, only on the second fraction containing the strips of PE; this second separation effectively removes the light contaminants of PP, and their proportion, within said second fraction, is lowered to a content of less than 1%;
dust is then removed by implementing a vibrating screen or a wobble screen or else a cyclone separator;
washing each of the fractions with water.

Following the cleaning of each of said two fractions:
a first extruder is fed with said first cleaned fraction comprising the PP fragments, so as to obtain PP granules, and
a second extruder is fed with said second fraction cleaned with the shredded strips of PE, so as to obtain PE granules.

The cleaning as well as the extrusion and granulation of each material are carried out by means of methods known to the person skilled in the art, by applying parameters already used in the state of the art.

The implementation of the method for shredding and recycling used big-bags according to the invention therefore makes it possible, in a particularly advantageous way, to produce PP granules and PE granules having characteristics in compliance for industrial reuse of these materials.

The present invention also relates to a facility for shredding and recycling used big-bags.

The facility is more specifically able to allow the implementation of the method of the invention as described above.

Said facility comprises at least the elements detailed below:
a unit for compacting at least one big-bag;
downstream of this compacting unit a feed conveyor is arranged, regularly feeding compacted big-bag(s) into a unit for shredding said at least one big-bag through cutting means; produced at this shredding unit, by said cutting means, is a raw shredded material composed of polyethylene strips on the one hand, and polypropylene fragments on the other hand,
means for feeding a loader with said raw material that exits the shredding unit; said loader comprises means for calibrating and managing the intake flow rate of said shredded material into a separation unit positioned downstream;
a separation unit consisting, in a way particular to the facility of the invention, of a shaker able to separate a first fraction of polypropylene fragments from a second fraction of polyethylene strips;
first means for conveying said second fraction from the shaker to a second shredding unit;
second means of conveying said second shredded fraction from said second shredding unit to a separation and cleaning unit;
fourth means for conveying said first fraction of fragments directly from said shaker to said separation and cleaning unit, considering that the two fractions are processed separately at this unit;
downstream of said separation and cleaning unit, first extrusion means fed with said first cleaned fraction containing the PP fragments and,
also downstream of the separation and cleaning unit, second extrusion means fed with said second cleaned fraction and containing the shredded strips of PE.

It should be noted that, advantageously, each of the extruders is provided with the usual degassing and filtration equipment in order to melt the plastics, PE and PP, and to transform them into reusable granules.

To return now to the shaker that the facility of the present invention comprises, it is provided, most preferentially, in its lower part, with an apron composed of a plurality of fixed grids or parallel bars. Two grids or two adjacent bars are advantageously separated from one another by a distance of between 1 and 3 cm.

Said shaker further comprises, in its upper part, a succession of a plurality of articulated rods containing tips, which rods are driven by an alternating and irregular rotational movement from 20 to 90°.

This shaker assembly operates so as to spray the clusters of plastic materials resulting from the shredding from one rod to the other, so as to untangle them, and to sufficiently shake these clumps of plastic to extract therefrom the fragmented particles of PP, coming from the external outer, which are then evacuated through the set of lower rods and recovered by a conveyor belt.

The PE strips coming from the internal bag are, for their part, evacuated at the end of the shaker assembly.

Consequently, upon completion of this separation two fractions are obtained by the shaker, the compositions of which have already been mentioned above:
PP fragments, the PE contamination rate of which is less than 10%;
polyethylene strips whose degree of contamination by PP fragments is less than 2%.

The cutting means comprised in the shredding unit, in a first embodiment of the facility according to the invention, consist of a multi-blade rotor.

In a second embodiment of the facility according to the invention, the cutting means consist of a guillotine cutter.

The features that have been described in connection with the method for shredding and recycling used big-bags are transposable to the facility and vice versa.

1. A method for shredding and recycling used big-bags having a continuous inner polyethylene bag and an external woven polypropylene outer, the method comprising, taken in order:
compacting at least one big-bag to a thickness of less than 20 cm;
conveying the at least one compacted big-bag to a shredding unit, and
shredding the at least one compacted big-bag at the shredding unit, wherein a feed rate at which the compacted big-bag is conveyed to the shredding unit and a cutting frequency of the shredding unit perform cuts in a range of 100 to 1000 cuts/m on the at least one compacted big-bag so as to obtain strips of polyethylene from the internal bag, the strips having a width in a range of from 1 to 10 mm and a length of up to 1000 mm, and fragments of the external polypropylene outer in a form of partially unwoven pieces and filaments having a width in a range of from 1 to 2 mm and a length of up to 500 mm;
separating the polyethylene strips from the polypropylene fragments and obtaining a first fraction of polypropylene fragments and a second fraction of polyethylene strips, and processing the second fraction of polyethylene strips by performing a second shredding of the polyethylene strips;
cleaning the first and second fractions by performing, on each of the fractions:
at least one air separation;
dust removal;
washing with water; and
feeding a first extruder with the cleaned first fraction of polypropylene fragments in order to obtain polypropylene granules and a second extruder with the cleaned second fraction of shredded polyethylene strips in order to obtain polyethylene granules.

2. The method for shredding and recycling used big-bags according to claim 1, wherein cuts in a range of from 200 to 500 cuts/m are applied to per compacted big-bag.

3. The method for shredding and recycling used big-bags according to claim 1, wherein the at least one compacted big-bag is conveyed to the shredding unit by a conveyor belt, at a feed rate in a range of from 14.4 m/min to 144 m/min, and wherein the shredding unit at which the shredding is performed comprises a multi-blade rotor, a cutting frequency of which is equal to 240 cuts per second.

4. The method for shredding and recycling used big-bags according to claim 3, wherein the at least one compacted big-bag is conveyed to the shredding unit at a feed rate in a range of from 28.8 to 72 m/min.

5. The method for shredding and recycling used big-bags according to claim 1, wherein the at least one compacted big-bag is conveyed to the shredding unit by a conveyor belt at a feed rate in a range of from 0.25 m/min to 2.5 m/min, and the shredding unit at which the shredding is performed comprises a guillotine cutter, a cutting frequency of which is equal to 250 cuts per minute.

6. The method for shredding and recycling used big-bags according to claim 5, wherein the at least one compacted big-bag is conveyed to the shredding unit at a feed rate in a range of from 0.5 to 1.25 m/min.

7. The method for recycling used big-bags according to claim 1, wherein the at least one big-bag is compacted to a thickness in a range of from 3 to 5 cm.

8. The method for recycling used big-bags according to claim 1, wherein, during the cleaning of the first and second fractions, the following actions are performed:
on each of the first and second fractions, a first air separation capable of enabling the extraction of heavy contaminants;
on the second fraction containing the strips of polyethylene, a second air separation capable of enabling elimination of the polypropylene and lowering a proportion of the propylene within the second fraction to a content of less than 1%.

9. A facility for shredding and recycling used big-bags, the big-bags comprising a continuous polyethylene inner bag and an external woven polypropylene outer, the facility being adapted for implementing the method according to claim 1, the facility comprising:
a unit for compacting at least one big-bag,
a conveyor belt arranged downstream of the unit for compacting at least one big-bag,
a shredding unit, wherein the conveyor belt feeds the at least one compacted big-bag to the shredding unit, the shredding unit comprising means for cutting the at least one big-bag into a shredded raw material consisting of polyethylene strips and polypropylene fragments
a loader,
means for feeding the shredded raw material to the loader,
a separation unit, the loader comprising means for calibrating and managing the intake flow rate of the shredded raw material into the separation unit, the separation unit comprising at least one shaker capable of separating a first fraction of polypropylene fragments from a second fraction of polyethylene strips,
a second shredding unit,
first means for conveying the second fraction from the at least one shaker to the second shredding unit,
a separation and cleaning unit,
second means for conveying the second shredded fraction from the second shredding unit to the separation and cleaning unit,
fourth means for conveying the first fraction of fragments directly from the at least one shaker to the separation and cleaning unit,
first extrusion means placed downstream of the separation and cleaning unit, the first extrusion means being fed with the first cleaned fraction of polypropylene fragments, and
second extrusion means fed with the second cleaned fraction of shredded polyethylene strips.

10. The facility for shredding and recycling used big-bags according to claim 9, wherein the shaker comprises, in a lower part thereof, an apron having a plurality of fixed grids or parallel bars, any two of the grids or adjacent bars being separated by a distance in a range of from 1 to 3 cm, and in an upper part thereof, a succession of a plurality of articulated rods containing tips, the articulated rods being driven by an alternating and irregular rotational movement in a range of from 20 to 90°.

11. The facility for shredding and recycling used big-bags according to claim 9, wherein the cutting means of the shredding unit comprises a multi-blade rotor.

12. The facility for shredding and recycling used big-bags according to claim 9, wherein the cutting means of the shredding unit comprises a guillotine cutter.

13. The facility for shredding and recycling used big-bags according to claim 10, wherein the cutting means of the shredding unit comprises a multi-blade rotor.

14. The facility for shredding and recycling used big-bags according to claim 10, wherein the cutting means of the shredding unit comprises a guillotine cutter.

15. The method for recycling used big-bags according to claim 8, wherein, during the first air separation capable of enabling the extraction of heavy contaminants, contaminants including metal, wood, paper, and mineral particles are extracted.

16. The method for recycling used big-bags according to claim 2, wherein the at least one big-bag is compacted to a thickness in a range of from 3 to 5 cm.

17. The method for recycling used big-bags according to claim 2, wherein, during the cleaning of the first and second fractions, the following actions are performed:
on each of the first and second fractions, a first air separation capable of enabling the extraction of heavy contaminants;
on the second fraction containing the strips of polyethylene, a second air separation capable of enabling elimination of the polypropylene and lowering a proportion of the propylene within the second fraction to a content of less than 1%.

18. The method for recycling used big-bags according to claim 17, wherein, during the first air separation capable of enabling the extraction of heavy contaminants, contaminants including metal, wood, paper, and mineral particles are extracted.

19. The method for recycling used big-bags according to claim 3, wherein the at least one big-bag is compacted to a thickness in a range of from 3 to 5 cm.

20. The method for recycling used big-bags according to claim 3, wherein, during the cleaning of the first and second fractions, the following actions are performed:
on each of the first and second fractions, a first air separation capable of enabling the extraction of heavy contaminants;
on the second fraction containing the strips of polyethylene, a second air separation capable of enabling elimination of the polypropylene and lowering a proportion of the propylene within the second fraction to a content of less than 1%.
